(19) United States
(12) Patent Application Publication
(10) Pub. No.: US 2018/0313662 A1
(43) Pub. Date: Nov. 1, 2018

(54) VEHICLE ENTERTAINMENT METHOD AND SYSTEM

(71) Applicant: GM GLOBAL TECHNOLOGY OPERATIONS LLC, Detroit, MI (US)

(72) Inventors: SAMUEL AMSTUTZ, HOWELL, MI (US); MATTHEW S. STOUT, HARTLAND, MI (US)

(73) Assignee: GM GLOBAL TECHNOLOGY OPERATIONS LLC, Detroit, MI (US)

(21) Appl. No.: 15/499,815

(22) Filed: Apr. 27, 2017

(51) Int. Cl. G01C 21/36; B60R 16/037

(52) U.S. Cl. CPC G01C 21/3697; G01C 21/362; B60R 16/037; G01C 21/3661; G01C 21/3614; G01C 21/3676

(57) ABSTRACT

Methods and systems are provided for controlling the providing of entertainment content for passengers of a vehicle. In one example, the vehicle includes an input device, a processor, and a display. The input device is configured to obtain an input as to a destination for a vehicle drive for the vehicle. The processor is coupled to the input device, and is configured to determine an expected duration of the vehicle drive to the destination and generate a content list of a plurality of content items for entertainment of one or more passengers of the vehicle, based on the expected duration of the vehicle drive and a running time for each of the plurality of content items. The display is coupled to the processor, and is configured to provide the content list in accordance with instructions provided by the processor.

### TECHNICAL FIELD

The technical field generally relates to the field of vehicles and, more specifically, to methods and systems for providing entertainment in a vehicle.

### BACKGROUND

Many vehicles include entertainment systems that provide content for passengers inside the vehicle. However, in certain circumstances the entertainment system may not always provide optimal choices or selections for the vehicle drive.

Accordingly, it is desirable to provide improved methods and systems for providing entertainment content for passengers of a vehicle during a vehicle drive. Furthermore, other desirable features and characteristics of the present invention will become apparent from the subsequent detailed description of the invention and the appended claims, taken in conjunction with the accompanying drawings and this background of the invention.

### SUMMARY

In accordance with an exemplary embodiment, a method is provided. The method includes obtaining an input as to a destination for a vehicle drive for a vehicle; determining, via a processor, an expected duration of the vehicle drive to the destination; and providing, via instructions provided by the processor, a content list of a plurality of content items for entertainment of one or more passengers of the vehicle, based on the expected duration of the vehicle drive and a running time for each of the plurality of content items.

In accordance with another exemplary embodiment, a system is provided. The system includes an input device and a processor. The input device is configured to obtain an input as to a destination for a vehicle drive for a vehicle. The processor is coupled to the input device, and is configured to determine an expected duration of the vehicle drive to the destination and provide a content list of a plurality of content items for entertainment of one or more passengers of the vehicle, based on the expected duration of the vehicle drive and a running time for each of the plurality of content items.

In accordance with a further exemplary embodiment, a vehicle is provided. The vehicle includes an input device, a processor, and a display. The input device is configured to obtain an input as to a destination for a vehicle drive for the vehicle. The processor is coupled to the input device, and is configured to determine an expected duration of the vehicle drive to the destination and generate a content list of a plurality of content items for entertainment of one or more passengers of the vehicle, based on the expected duration of the vehicle drive and a running time for each of the plurality of content items. The display is coupled to the processor, and is configured to provide the content list in accordance with instructions provided by the processor.

### DESCRIPTION OF THE DRAWINGS

The present disclosure will hereinafter be described in conjunction with the following drawing figures, wherein like numerals denote like elements, and wherein:

FIG. 1 is a functional block diagram of a vehicle that includes a control system for providing entertainment for a passenger of the vehicle, and with the vehicle depicted along with a portable electronic device of the passenger and a remote server, in accordance with an exemplary embodiment;

FIG. 2 is a flowchart of a process for providing entertainment for a passenger of a vehicle, and that can be implemented in connection with the vehicle, the control system, the portable electronic device, and the remote server of FIG. 1, in accordance with an exemplary embodiment; and

FIGS. 3-5 provide exemplary display screens for entertainment content for a passenger for a vehicle drive, and that can be implemented in connection with the vehicle, the control system, the portable electronic device, and the remote server of FIG. 1 and the process of FIG. 2, in accordance with an exemplary embodiment.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

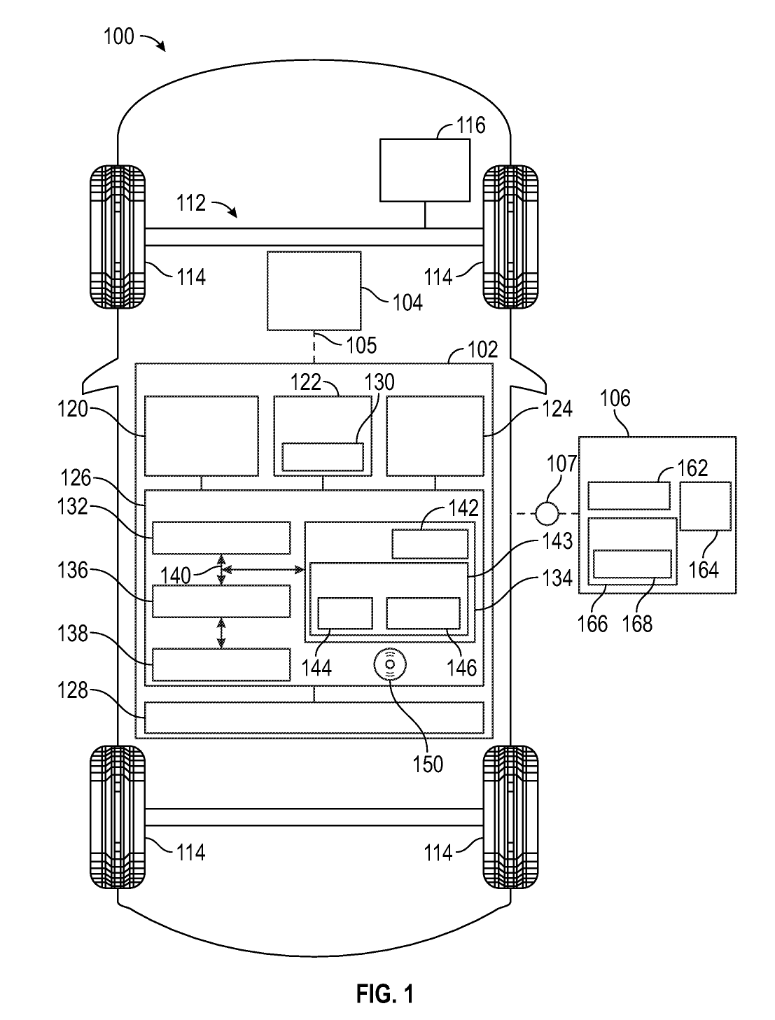

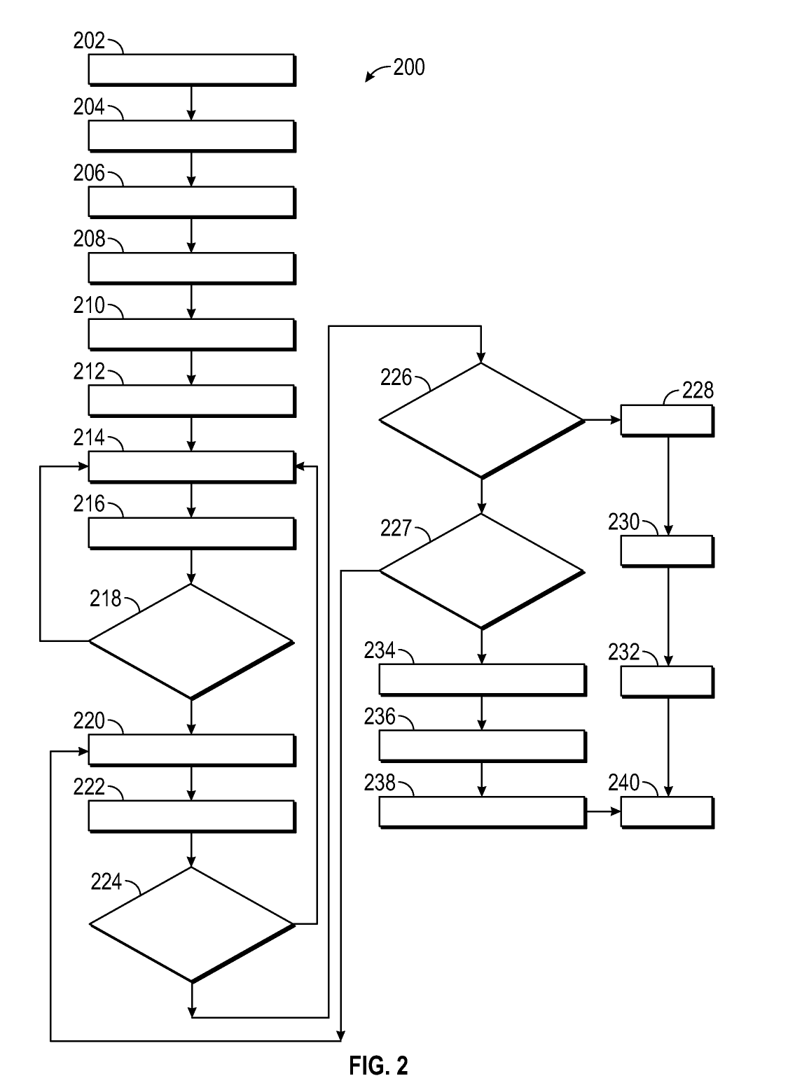

FIG. 1 illustrates a vehicle 100, according to an exemplary embodiment. As described in greater detail further below, the vehicle 100 includes a control system 102 for controlling entertainment content for passengers of the vehicle 100, in accordance with the steps of the process 200 described further below in connection with FIGS. 2-5, in accordance with exemplary embodiments.

The vehicle 100 preferably comprises an automobile. The vehicle 100 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles in certain embodiments. In certain embodiments, the vehicle 100 may also comprise a motorcycle or other vehicle, or other system.

The vehicle 100 includes a body 110 that is arranged on a chassis 112. The body 110 substantially encloses other components of the vehicle 100. The body 110 and the chassis 112 may jointly form a frame. The vehicle 100 also includes a plurality of wheels 114. The wheels 114 are each rotationally coupled to the chassis 112 near a respective corner of the body 110 to facilitate movement of the vehicle 100. In one embodiment, the vehicle 100 includes four wheels 114, although this may vary in other embodiments (for example for trucks and certain other vehicles).

A drive system 116 is mounted on the chassis 112, and drives the wheels 114. The drive system 116 preferably comprises a propulsion system. In certain exemplary embodiments, the drive system 116 comprises an internal combustion engine and/or an electric motor/generator, coupled with a transmission thereof. In certain embodiments, the drive system 116 may vary, and/or two or more drive systems 116 may be used. By way of example, the vehicle 100 may also incorporate any one of, or combination of, a number of different types of propulsion systems, such as, for example, a gasoline or diesel fueled combustion engine, a “flex fuel vehicle” (FFV) engine (i.e., using a mixture of gasoline and alcohol), a gaseous compound (e.g., hydrogen and/or natural gas) fueled engine, a combustion/electric motor hybrid engine, and an electric motor.

The control system 102 controls entertainment for passengers of the vehicle 100. In various embodiments, the control system 102 determines an expected duration for a current vehicle drive, and presents options for and coordinates the providing of entertainment content for passengers of the vehicle 100 based on the expected duration for the current vehicle drive, in addition to various other possible factors. In certain embodiments, the control system 102 interacts with a portable electronic device 104 (e.g., a smart phone, a portable DVD or movie player, an MP3 player, and/or another type of portable electronic device) of one or more of the passengers and/or a remote server 106 in providing these functions. In addition, in various embodiments, the control system 102 provides these functions are other functionality in accordance with the steps of the process 200 described further below in connection with FIGS. 2-5.

As depicted in FIG. 1, the control system 102 includes a transceiver 120, an input device 122, a navigation system 124, a controller 126, and a display 128. It will be appreciated that in certain embodiments the control system 102 may include one or more other components, and/or that one or more components depicted in FIG. 1 as being part of the control system 102 may be part of and/or coupled to the portable electronic device 104 and/or the drive system 116 and/or one or more other vehicle components, and/or the remote server 106 and/or one or more other devices and/or system.

In certain embodiments, the transceiver 120 receives transmissions from, and/or provides transmissions to, the portable electronic device 104 and/or the remote server 106. In certain embodiments, the transmissions pertain to entertainment content (e.g., movies, television shows, e-books, and/or other content) that may be stored in and/or have pertain to functionality of the portable electronic device 104 and/or the remote server 106.

Also in certain embodiments, the input device 122 receives inputs from one or more passengers of the vehicle 100. In various embodiments, the input device 122 may comprise any number of different types of devices such as, by way of example only, a touch screen, one or more buttons or knows, a joystick, a microphone, and so on, engaged by the passenger. Also in various embodiments, the input device 122 includes an associated sensor 130 for receiving passenger inputs. In various embodiments, the passenger inputs include selections pertaining to entertainment content to be provided within the vehicle 100. In certain embodiments, the passenger inputs may also pertain to a desired geographic destination for the current vehicle drive—in other embodiments these inputs may be provided via a separate input device, such as of the navigation system 124.

The navigation system 124 obtains location information pertaining to the vehicle 100. In various embodiments, the navigation system 124 includes and/or is coupled to one or more antennas of the vehicle 100 that receive location information from one or more satellite based systems, such as a global positioning system (GPS) system. Also in certain embodiments, the navigation system 124 may comprise the input device 122 and/or components thereof for receiving passenger inputs (e.g., as to a preferred destination for the current vehicle drive) and/or may have its own input device.

The controller 126 controls operation of the control system 102, and the providing of entertainment for passengers of the vehicle 100, in various embodiments. Also in various embodiments, the controller 126 determines a route and expected duration of time for the current vehicle drive, selects appropriate content items based on the expected duration of time, and provides such appropriate content for the passengers (e.g., on the display 128) based on these factors as well as inputs received from the passengers. In one embodiment, the controller 126 is coupled to the transceiver 120, the input device 122, the navigation system 124, and the display 128. In certain embodiments, the controller 126 is also coupled to the portable electronic device 104 and/or the remote server 106. Also in one embodiment, the controller 126 is disposed within the control system 102, within the vehicle 100. In addition, in certain embodiments, the controller 126 and/or certain components thereof can be placed in the portable electronic device 104, and/or outside vehicle, such as in the remote server 106, or in the cloud or on a remote smart device, and so on.

As depicted in FIG. 1, the controller 126 comprises a computer system. In certain embodiments, the controller 126 may also include the transceiver 120, the input device 122, the navigation system 124, the portable electronic device 104, the remote server 106, and/or other devices and/or components thereof. In addition, it will be appreciated that the controller 126 may otherwise differ from the embodiment depicted in FIG. 1. For example, the controller 126 may be coupled to or may otherwise utilize one or more remote computer systems and/or other control systems, for example as part of one or more of the above-identified vehicle 100 devices and systems.

In the depicted embodiment, the computer system of the controller 126 includes a processor 132, a memory 134, an interface 136, a storage device 138, and a bus 140. The processor 132 performs the computation and control functions of the controller 126, and may comprise any type of processor or multiple processors, single integrated circuits such as a microprocessor, or any suitable number of integrated circuit devices and/or circuit boards working in cooperation to accomplish the functions of a processing unit. During operation, the processor 132 executes one or more programs 142 contained within the memory 134 and, as such, controls the general operation of the controller 126 and the computer system of the controller 126, generally in executing the processes described herein, such as the process 200 described further below in connection with FIGS. 2-5.

The memory 134 can be any type of suitable memory. For example, the memory 134 may include various types of dynamic random access memory (DRAM) such as SDRAM, the various types of static RAM (SRAM), and the various types of non-volatile memory (PROM, EPROM, and flash). In certain examples, the memory 134 is located on and/or co-located on the same computer chip as the processor 132. In the depicted embodiment, the memory 134 stores the above-referenced program 142 along with one or more stored values 143, including map data 144 and entertainment content 146.

The bus 140 serves to transmit programs, data, status and other information or signals between the various components of the computer system of the controller 126. The interface 136 allows communication to the computer system of the controller 126, for example from a system driver and/or another computer system, and can be implemented using any suitable method and apparatus. The interface 136 can include one or more network interfaces to communicate with other systems or components. The interface 136 may also include one or more network interfaces to communicate with technicians, and/or one or more storage interfaces to connect to storage apparatuses, such as the storage device 138.

The storage device 138 can be any suitable type of storage apparatus, including direct access storage devices such as hard disk drives, flash systems, and optical disk drives. In one exemplary embodiment, the storage device 138 comprises a program product from which memory 134 can receive a program 142 that executes one or more embodiments of one or more processes of the present disclosure, such as the steps of the process 200 (and any sub-processes thereof) described further below in connection with FIGS. 2-5. In another exemplary embodiment, the program product may be directly stored in and/or otherwise accessed by the memory 134 and/or a disk (e.g., disk 150), such as that referenced below.

The bus 140 can be any suitable physical or logical means of connecting computer systems and components. This includes, but is not limited to, direct hard-wired connections, fiber optics, infrared and wireless bus technologies. During operation, the program 142 is stored in the memory 134 and executed by the processor 132.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 132) to perform and execute the program. Such a program product may take a variety of forms, and the present disclosure applies equally regardless of the particular type of computer-readable signal bearing media used to carry out the distribution. Examples of signal bearing media include: recordable media such as disks, hard drives, memory cards and optical disks, and transmission media such as digital and analog communication links. It will be appreciated that cloud-based storage and/or other techniques may also be utilized in certain embodiments. It will similarly be appreciated that the computer system of the controller 126 may also otherwise differ from the embodiment depicted in FIG. 1, for example in that the computer system of the controller 126 may be coupled to or may otherwise utilize one or more remote computer systems and/or other control systems.

In various embodiments, the display 128 provides selected content items for the passengers inside the vehicle 100. Also in various embodiments, the display 128 provides the content in accordance with instructions provided by the processor 132. In certain embodiments, the display 128 includes a built-in screen (e.g., a light emitting diode, or “LED” screen) within the vehicle 100. In certain embodiments, the display 128 also includes speakers and/or other audio components. In addition, also in certain embodiments, the display 128 may also include an interface and/or input device for the passenger to provide content-related inputs (e.g., including the input device 122 and/or a separate input device and/or one or more components thereof). Also in certain embodiments, the display 128 may also include a display (e.g., a display screen and/or speakers) of the portable electronic device 104.

In various embodiments, the portable electronic device 104 provides information and/or other assistance for the control system 102 for providing content for the passengers. In certain embodiments, the portable electronic device 104 includes information pertaining to entertainment content (e.g., movies, television shows, e-books, and/or other content) of the passengers. For example, in certain embodiments, the portable electronic device 104 includes a list (e.g., a playlist) of content preferred by the passengers and/or information pertaining to recent content viewed by the passengers and/or content that the passengers may have recently been in the midst of viewing without finishing. In certain embodiments, the portable electronic device 104 provides the content itself as selected by the passengers. In addition, in certain embodiments, the portable electronic device 104 includes an input device (e.g., as part of the input device 122 and/or as a separate input device) for the passenger to make content items and/or other entertainment inputs for the control system 102. Also in certain embodiments, the portable electronic device 104 may provide a screen and/or other display for the content.

In certain embodiments, the portable electronic device 104 comprises a smart phone, a portable DVD or movie player, an MP3 player, and/or another type of portable electronic device of the passenger of the vehicle 100. In certain embodiments, the passenger may bring the portable electronic device 104 into the vehicle 100. In other embodiments, the portable electronic device 104 may be part of the vehicle 100. In certain embodiments, the portable electronic device 104 comprises a smart phone, and the control system 102 (e.g., including the programs 142 thereof) comprise an application (or “app”) for the smart phone. However, this may vary in other embodiments.

In addition, in various embodiments the control system 102 communicates with the portable electronic device 104 via one or more communication links 105. In one embodiment, the communication link 105 comprises a wired connection (e.g., in which the portable electronic device 104 may be plugged into the vehicle 100, and the control system 102 thereof). In certain other embodiments, the communication link 105 comprises one or more wireless connections, such as one or more cellular and/or short range wireless connections.

In certain embodiments, the remote server 106 provides information and/or other assistance for the control system 102 for providing content for the passengers. In certain embodiments, the remote server provides entertainment content (e.g., movies, television shows, e-books, and/or other content) for the passengers. For example, in certain embodiments, the remote server 106 includes a list (e.g., a playlist) of content preferred by the passengers and/or information pertaining to recent content viewed by the passengers and/or content that the passengers may have recently been in the midst of viewing without finishing. In addition, in certain embodiments, the remote server 106 provides the content itself as selected by the passengers.

In the depicted embodiment, the remote server 106 includes a processor 162, a transceiver 164, and a memory 166. In various embodiments, the processor 162 controls operation of the remote server 106, including communicating with and providing content and/or content lists for the control system 102 of the vehicle 100. Also in various embodiments, the transceiver communicates with the control system 102 with a wireless network 107 (e.g., a cellular, satellite, and/or other wireless network, for communicating with the transceiver 120 of the control system 102). In addition, in various embodiments, the memory 166 includes stored entertainment content 168 that may be provided for the passengers of the vehicle 100, for example on the display 128 of the vehicle 100 in accordance with instructions provided via the processor 132.

FIG. 2 is a flowchart of a process 200 for providing entertainment for a passenger of a vehicle, in accordance with an exemplary embodiment. In various embodiments, the process 200 can be implemented in connection with the vehicle 100, the control system 102, the portable electronic device 104, and the remote server 106 of FIG. 1, in accordance with an exemplary embodiment.

As depicted in FIG. 2, the process begins at step 202. In one embodiment, the process 200 begins when a vehicle drive or ignition cycle begins, for example when a driver approaches or enters the vehicle 100, or when the driver turns on the vehicle and/or an ignition therefor (e.g. by turning a key, engaging a keyfob or start button, and so on). In one embodiment, the steps of the process 200 are performed continuously during operation of the vehicle 100.

Location data is obtained at step 204. In various embodiments, the location data comprises a particular geographic location, or position, of the vehicle 100. Also in various embodiments, the location data is obtained via the navigation system 124 of FIG. 1, such as one or more GPS and/or other satellite based navigation systems.

One or more destination inputs are obtained at step 206. In certain embodiments, the input device 122 obtains destination inputs from the passenger (e.g., via one or more sensors 130 of the input device 122) as to a desired destination for the current vehicle drive. In certain embodiments, the desired destination may be obtained via one or more input devices of one or more other devices and/or systems, such as the portable electronic device 104 and/or the navigation system 124 of FIG. 1. In addition, in certain embodiments, the destination inputs may also include passenger inputs as to one or more intermediate locations that the passengers prefer the route to include (e.g., any particular rest stops, attractions, or other point of interests).

A route of travel is determined for the vehicle drive at step 208. In various embodiments, the processor 132 determines a route of travel for the vehicle 100 to travel during the current vehicle drive to the desired destination. In addition, in certain embodiments in which passenger inputs are also obtained with respect to intermediate locations, then the processor 132 may also make sure to include, if possible, the intermediate locations as part of the route. In certain embodiments, it will be appreciated that the processor 132 may be part of, and/or may perform these functions, as part of one or more other systems, such as the navigation system 124 of FIG. 1.

An expected duration is calculated at step 210 for the route. Specifically, in various embodiments, the processor 132 calculates an expected duration of time that it would take for the vehicle 100 to travel along the route of step 208 to the desired destination of step 206, based on any currently available information (such as the day of the week, time of day, weather, road conditions, traffic conditions, and so on, as may be obtained, for example via the remote server 106 and/or one or more other sources). Similar to the discussion above, it will be appreciated that the processor 132 may be part of, and/or may perform some or all of these functions, as part of one or more other systems, such as the navigation system 124 of FIG. 1.

A content list is generated at step 212. In various embodiments, the content list comprises a plurality of content items for entertainment of one or more passengers of the vehicle (such as movies, television shows, e-books, and/or other content) based on the expected duration of the vehicle drive from step 210 along with a running time for each of the plurality of content items.

In various embodiments, the processor 132 of FIG. 1 generates the content list by identifying a plurality of content items that are consistent with known preferences of the one or more passengers and that have running times that are consistent with the expected duration of the vehicle drive. In certain embodiments, consistency with passenger preferences may be determined, for example, based on (i) a play list for the passengers as stored on the portable electronic device 104, the memory 134 of the vehicle 100, and/or the memory 166 of the remote server 106 of FIG. 1; (ii) a list of content items that have recently been viewed by the passengers, including any content items for which viewing may still be in progress, and/or for which viewing has not yet been completed for a most recent vehicle drive and/or other event; (iii) other history and/or data pertaining to preferences of the passengers as to particular content items, genres of content items, and so on.

Also in certain embodiments, consistency with the expected duration of the vehicle drive may include content items (i) that can be viewed in their entirety during the expected duration of the vehicle (e.g., content items with running times that are less than or equal to the expected duration of the vehicle drive); (ii) content items that can be viewed almost in their entirety during the expected duration of the vehicle drive (e.g., content items with running times that are only a few minutes greater than the expected duration of the vehicle drive, in case some passengers may not missing some of the credits at the end of a movie or show, or the like); and (iii) groups of multiple content items that can collectively viewed within the current vehicle drive (e.g., groups of content items each having individual running times that, when added together, are less than or equal to the expected duration of the vehicle drive, or in some embodiments that are within a few minutes of the expected duration of the vehicle drive).

Also in certain embodiments, the content list is further generating by sorting the plurality of content items in order of compatibility of the respective running times with the expected duration of the vehicle drive. For example, in certain embodiments, the content items (or groups of content items) with running times (or combined running times) that are closest to the expected duration of the vehicle drive (and, in some embodiments, without exceeding the expected duration of the vehicle drive) are provided at or near the top of the list. In addition, in certain embodiments in which the passengers have provided inputs for intermediate locations (e.g., rest stops) for the vehicle 100 to stop at en route to the final destination, the content items may be sorted so that the content items at or near the top of the list include different content items that would be completed as the vehicle 100 approaches the different intermediate locations, and so on.

The content list is displayed for the passengers at step 214. In various embodiments, the processor 132 of FIG. 1 provides the content list for the passengers within the vehicle 100 via the display 128. Similar to the discussion above, it will be appreciated that in various embodiments the display 128 may be part of a display screen (e.g., LED) built into the vehicle 100, and/or as part of the portable electronic device 104 and/or the navigation system 124, among other possible devices and/or systems. Also in various embodiments, as part of the providing of the content list, the passengers are invited to select content item(s) from the list and/or to provide other content inputs, for example via the input device 122 of FIG. 1 and/or the portable electronic device 104 of FIG. 1.

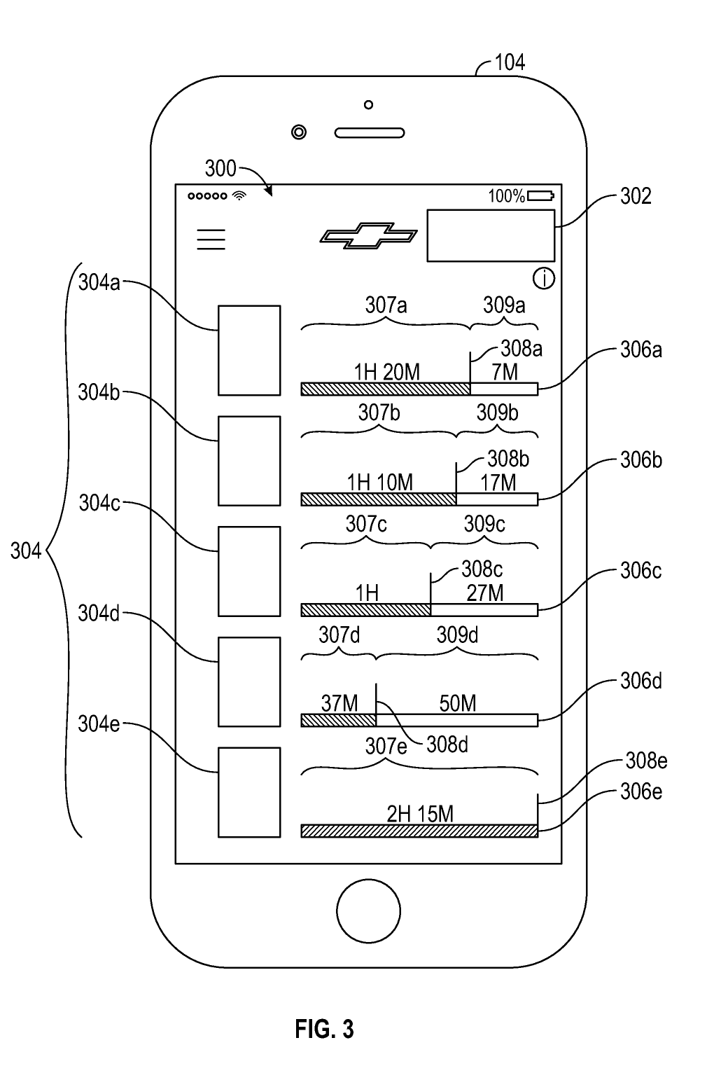

With reference to FIG. 3, an exemplary display 300 is depicted showing a content list in accordance with steps 212 and 214 of FIG. 2, in accordance with an exemplary embodiment. While the display 300 is depicted as being as provided on a smart phone corresponding to the portable electronic device 104 of FIG. 1, it will be appreciated that in various embodiments the display 300 may also similarly be provided on a vehicle display screen (e.g., the display 128 of FIG. 1), a screen of the navigation system 124 of FIG. 1, and/or one or more other devices and/or systems.

As shown in FIG. 3, in one embodiment the display 300 includes the estimated duration of the vehicle drive 302 along with the plurality of content items 304(a)-304 (e) of the content list. While five content items are depicted on the exemplary list of FIG. 3, it will be appreciated that the content list may comprise any number of content items in various embodiments.

Also as shown in FIG. 3, in one embodiment, for each content item 304(a)-304(e), identification information (e.g., a photo or image) is provided, along with a respective time bar 306(a)-306(e) that shows a relationship between the particular content item 304 and the expected duration 302 of the vehicle drive. Specifically, for each content item 304, a respective time bar 306 shows the running time 307 for the particular content item, along with a vertical line 308 that shows the end of the running time, and an amount of leftover time 309 that would remain for the vehicle drive after the completion of the particular content item 304.

For example, for the first content item 304(a) depicted in FIG. 3, the time bar 306(a) shows a running time 307(a) of one hour and twenty minutes (marked by vertical line 308(a)), along with leftover time 309(a) of seven minutes for the current vehicle drive. In one embodiment, the running time 307(a) is denoted with a first color (e.g., green), while the leftover time 309(a) is denoted with a second color (e.g., white).

By way of further example, for the second content item 304(b) depicted in FIG. 3, the time bar 306(b) shows a running time 307(b) of one hour and ten minutes (marked by vertical line 308(b)), along with leftover time 309(b) of seventeen minutes for the current vehicle drive. In one embodiment, the running time 307(b) is denoted with a first color (e.g., green), while the leftover time 309(b) is denoted with a second color (e.g., white).

By way of additional example, for the third content item 304(c) depicted in FIG. 3, the time bar 306(c) shows a running time 307(c) of one hour (marked by vertical line 308(c)), along with leftover time 309(c) of twenty seven minutes for the current vehicle drive. In one embodiment, the running time 307(c) is denoted with a first color (e.g., green), while the leftover time 309(c) is denoted with a second color (e.g., white).

By way of another example, for the fourth content item 304(d) depicted in FIG. 3, the time bar 306(d) shows a running time 307(d) of thirty seven minutes (marked by vertical line 308(d)), along with leftover time 309(d) of fifty minutes for the current vehicle drive. In one embodiment, the running time 307(d) is denoted with a first color (e.g., green), while the leftover time 309(d) is denoted with a second color (e.g., white).

By way of an additional example, for the fifth content item 304(e) depicted in FIG. 3, the time bar 306(e) shows a running time 307(e) of two hours and fifteen minutes (marked by vertical line 308(3)). For the fifth content item 304(e), there would be no leftover time. In fact, in this embodiment, the fifth content item 304(e) would not be finished in the current vehicle drive. Accordingly, in one embodiment, the running time 307(e) is denoted with a third color (e.g., red), for example to indicate that the running time 307(e) exceeds the expected duration 302 of the vehicle drive.

With reference back to FIG. 2, in various embodiments content inputs are received at step 216. In various embodiments, the content inputs comprise a selection of one or more of the content items from the content list. Also in various embodiments, the content inputs are received via the input device 122 of FIG. 1 (e.g., the sensor 130 thereof), and/or from the portable electronic device 104 of FIG. 1.

A determination is made at step 218 as to whether one or more content items were selected by the passengers of the vehicle 100. In certain embodiments, this determination is made by the processor 132 of FIG. 1 based on the content inputs from step 216.

If it is determined that the passengers have not selected any content items, then the process returns to step 214. Steps 214-218 continue until a determination is made in an iteration of step 218 that one or more content items have been selected.

Once it is determined in an iteration of step 218 that one or more content items have been selected, then additional information is provided for the selected content item(s) at step 220. Specifically, in certain embodiments, the processor 132 of FIG. 1 provides instructions for the display 128 of the vehicle 100 (and/or for the portable electronic device 104) to provide additional information (e.g., plot summary, characters, authors, actors, and so on) for the selected content item(s), along with an invitation for the passengers to provide additional content inputs, namely content selections. For example, in one embodiment, the passenger is provided the options of (i) playing the selected content item now; (ii) adding the selected content to a queue of content items; and (iii) going back to the previous screen (i.e., to the list of content items).

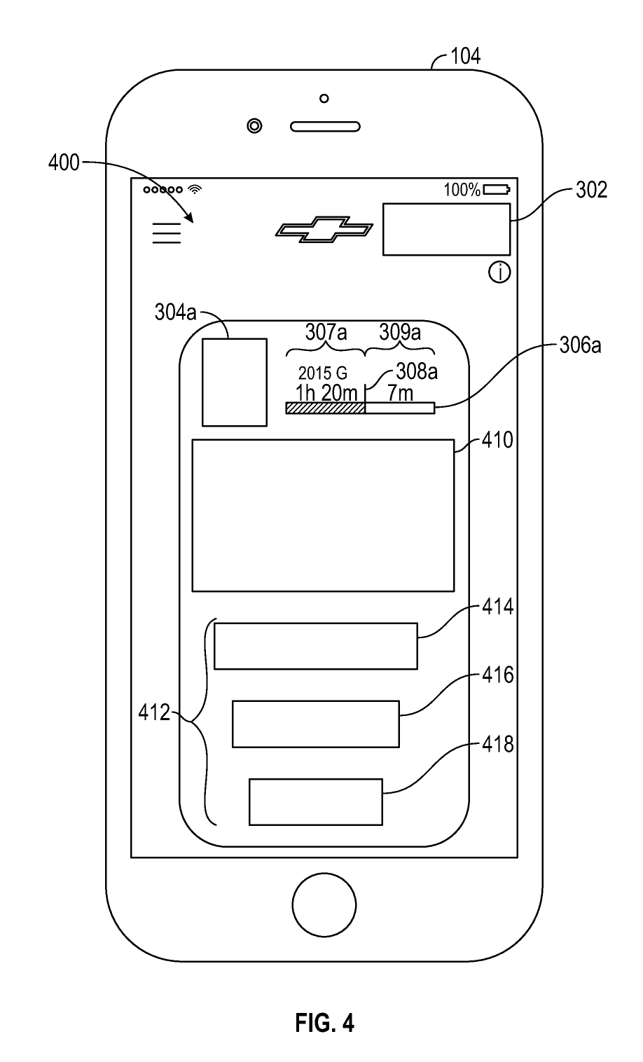

With reference to FIG. 4, an exemplary display 400 is depicted showing a menu in accordance with the additional content information provided in step 220, as discussed above. Similar to the discussion above with FIG. 3, while the display 400 is depicted as being as provided on a smart phone corresponding to the portable electronic device 104 of FIG. 1, it will be appreciated that in various embodiments the display 400 may also similarly be provided on a vehicle display screen (e.g., the display 128 of FIG. 1), a screen of the navigation system 124 of FIG. 1, and/or one or more other devices and/or systems.

As shown in FIG. 4, in one embodiment the display 400 includes the estimated duration of the vehicle drive 302. Also as depicted in FIG. 4, in one embodiment the display 400 also includes identification information (e.g., a photograph or other image) of the selected content item (e.g., 304(a)), along with the time bar 304(a) from the selected content item (e.g., similar to the discussion above with respect to FIG. 3), along with additional information 410 (e.g., plot summary, characters, authors, actors, and so on) regarding the selected content item.

Also as depicted in FIG. 4, in one embodiment the display 400 provides a menu 412 of choices for passenger inputs, similar to the discussion above for step 222. As shown in FIG. 4, in one embodiment, the menu 412 includes the following choices: (i) “Play Now” (414); (ii) “Add to Queue” (416); and (iii) “Back” (i.e., return to the previous screen, i.e., the display 300 of FIG. 3). It will be appreciated that the menu 412 choices may vary in different embodiments.

With reference back to FIG. 2, in various embodiments selection inputs are received at step 222. In various embodiments, the selection inputs comprise a selection from the menu 412 of the display 400 of FIG. 4 (i.e., “Play Now”; “Add to Queue”; or “Back”). Also in various embodiments, the selection inputs are received via the input device 122 of FIG. 1 (e.g., the sensor 130 thereof), and/or from the portable electronic device 104 of FIG. 1.

A determination is made at step 224 as to whether the selection inputs comprise a request to return to the previous screen (e.g., a “Back” request). In one embodiment, this determination is made by the processor 132 of FIG. 1.

If it is determined that the selection inputs comprise a request to return to the previous screen, then the process returns to step 214, and the content list (e.g., corresponding to the display 300 of FIG. 3) is provided. In certain embodiments, this step is performed in accordance with instructions provided by the processor 132 of FIG. 1 to the display 128 of the vehicle 100 and/or for the portable electronic device 104.

Conversely, if it is not determined that the selection inputs comprise a request to return to the previous screen, then the process proceeds instead to step 226, described below.

During step 226, a determination is made as to whether the selection inputs comprise a request to return to play the selected content item (e.g., a “Play Now” request). In one embodiment, this determination is made by the processor 132 of FIG. 1.

If it is determined that the selection inputs comprise a request to play the selected content item, then the process proceeds to step 228. During step 228, the selected content item is played for the passengers inside the vehicle 100. In various embodiments, the selected content item is played, or displayed, on the display 128 (and/or the portable electronic device 104) via instructions provided by the processor 132. In one embodiment, the content item is stored in the memory 134 of the vehicle 100 of FIG. 1 as content 146 thereof, and retrieved and/or played therefrom. In another embodiment, the content item is stored in the portable electronic device 104 of FIG. 1 and retrieved and/or played therefrom. In yet another embodiment, the content item is stored in the memory 166 of the vehicle 100 of FIG. 1 as content 168 thereof, and retrieved and/or played therefrom.

In addition, an overlay is generated at step 230. Specifically, in one embodiment, during step 230, the processor 132 generates an overlay of the route for the vehicle 100 (of step 208) interposed with the selected content item (of step 222), showing where along the route the selected content item will be played on the display 128 (and/or a display of the portable electronic device 104) inside the vehicle 100, utilizing the map data 144 stored in the memory 134 of FIG. 1.

The overlay is displayed at step 232 for the passengers inside the vehicle 100. Specifically, in various embodiments, during step 232, the overlay is provided, or displayed, on the display 128 and/or the portable electronic device 104 of FIG. 1 in accordance with instructions provided by the processor 132. In certain embodiments, the process then terminates at step 240.

With reference again to step 226, if it is determined that the selection inputs of step 222 do not comprise a play request, then a determination is made at step 227 as to whether the selection inputs comprise a “Queue” request (e.g., as to whether the passenger has requested that the selected content item be placed in a queue of content items to be played later on during the vehicle drive). In one embodiment, this determination is made by the processor 132 of FIG. 1.

If it is determined that the selection inputs comprise a “Queue” request, then at step 234 the selected content item is placed in a queue of selected content items to be played later on during the vehicle drive. In certain embodiments, this step is performed by the processor 132 of FIG. 1

In addition, an overlay is generated at step 236. Specifically, in one embodiment, during step 236, the processor 132 generates an overlay of the route for the vehicle 100 (of step 208) interposed with the queue of content items to be provided during the current vehicle drive, showing where along the route the selected content items in the queue will be played on the display 128 (and/or a display of the portable electronic device 104) inside the vehicle 100, utilizing the map data 144 stored in the memory 134 of FIG. 1.

The overlay is displayed at step 238 for the passengers inside the vehicle 100. Specifically, in various embodiments, during step 238, the overlay is provided, or displayed, on the display 128 and/or the portable electronic device 104 of FIG. 1 in accordance with instructions provided by the processor 132. In certain embodiments, the process then terminates at step 240.

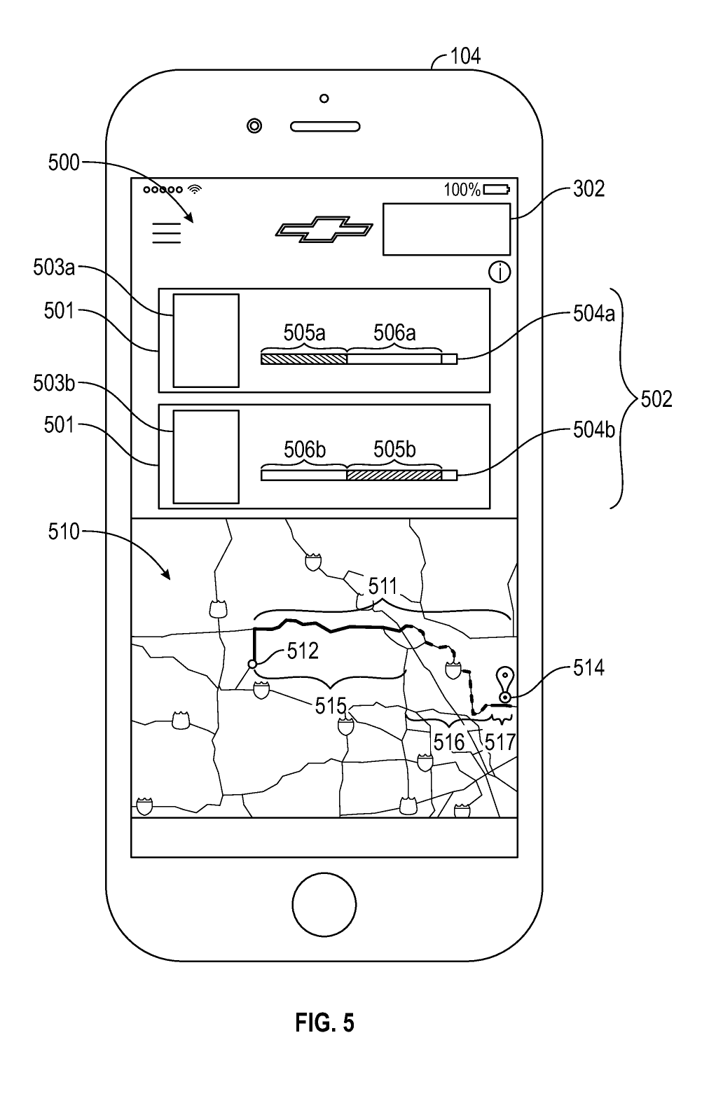

With reference to FIG. 5, an exemplary display 500 is depicted showing the above-described queues and overlays of steps 234-238, in accordance with an exemplary embodiment. Similar to the discussion above with FIGS. 3 and 4, while the display 500 is depicted as being as provided on a smart phone corresponding to the portable electronic device 104 of FIG. 1, it will be appreciated that in various embodiments the display 500 may also similarly be provided on a vehicle display screen (e.g., the display 128 of FIG. 1), a screen of the navigation system 124 of FIG. 1, and/or one or more other devices and/or systems.

As shown in FIG. 5, in one embodiment the display 500 includes the estimated duration of the vehicle drive 302. Also as depicted in FIG. 5, in one embodiment the display 500 includes a queue 502 of selected content items 503 in the queue. While the queue 502 is depicted as included two content items 503, namely, 503(a) and 503(b), it will be appreciated that the number will vary in different vehicle drives and in different embodiments.

Also as depicted in FIG. 5, in one embodiment each content item 503 in the queue 502 is presented inside a particular region 501 that includes identification information (e.g., a photo or image), along with a respective time bar 504 that includes a playing portion 505 during the vehicle drive in which the content item will not be playing, and a non-playing portion 506 of the vehicle drive in which the content item will not be playing.

For example, in one embodiment as depicted in FIG. 5, the first content item 503(a) will be playing during a first segment of the vehicle drive corresponding to portion 505(a) depicted in FIG. 5. In one embodiment, portion 505(a) is displayed in a certain color (e.g., purple) to indicate that this content item 503(a) is currently playing within the vehicle 100, while portion 506(a) (in which content item 503(a) will not be playing) is displayed in a different color (e.g., white).

In addition, also in one embodiment as depicted in FIG. 5, the second content item 503(b) will be playing, subsequently, during a second segment of the vehicle drive (i.e., after the first content item 503(a) is completed), corresponding to portion 505(b) depicted in FIG. 5. In one embodiment, portion 505(b) is displayed in a certain color (e.g., blue) to indicate that this content item 503(b) will be playing within the vehicle 100 during this segment of the vehicle drive in the future, while portion 506(b) (in which content item 503(b) will not be playing) is displayed in a different color (e.g., white).

Also as depicted in FIG. 5, in one embodiment an overlay 510 is provided for the content items with reference to the route of the vehicle drive, using the map data 144 of FIG. 1. As shown in FIG. 5, in one embodiment, the overlay 510 includes the route 511 for the vehicle drive, including a starting location 512 for the vehicle drive along with an ending location 514 (e.g., the destination) of the vehicle drive. In certain embodiments, any intermediate destinations (e.g., requested rest stops) may also be included as appropriate.

Also as shown in FIG. 5, the route 511 is broken up into segments 515, 516 in which different content items are to be played along the route 511 during the vehicle drive. For example, in the example depicted in FIG. 5, the first content item 503(a) is to be played during a first segment 515 of the vehicle drive (e.g., also corresponding to segment 505(a) above), and the second content item 503(b) is to be played during a second segment 516 of the vehicle drive (e.g., also corresponding to segment 505(b) above).

Similar to the discussions above, it will be appreciated that in various embodiments and in various different vehicle drives, the number of selected content items (and therefore the number of segments) will vary. In addition, as depicted in FIG. 5, in certain embodiments, one or more additional segments 517 may be provided to indicate that there is currently no content item scheduled to be played during such segment 517.

In addition, it is noted that for the overlay of steps 230, 232, a similar display may be utilized. For example, when a single content item is played during step 228, and a corresponding overlay is generated in step 230 and displayed 232, then in various embodiments the overlay will be similar to the overlay 510 of FIG. 5, with the exception that the overlay 510 may include a single segment 515 for a single content item, and so on.

In either case, the overlay provides the passengers with a convenient view of the route for the vehicle drive, interposed with the content item(s) that have been selected for the vehicle drive and the segment(s) thereof. This also allows for passengers to visualize where the vehicle 100 will be during different content item selections and/or portions thereof, and can also assist with planning for the vehicle drive, any desired rest stops, any discussions with children or other passengers as to how long the vehicle drive is expected to take and/or where along the vehicle drive the vehicle 100 is at any time (and with relation to the provided entertainment content items), and so on.

Accordingly, the systems, vehicles, and methods described herein provide for control of entertainment content for passengers inside a vehicle during a vehicle drive. In various embodiments, the systems, vehicles, and methods obtain content items that are compatible with an expected duration of the current vehicle drive, and provide a customized entertainment experience for the passengers based on the passengers' preferences and selections as well as the running times of the content items in comparison with the expected duration of the vehicle drive, in addition to a visualization of the vehicle drive in a map overlay in connection with the selected content items.

It will be appreciated that the systems, vehicles, and methods may vary from those depicted in the Figures and described herein. For example, the vehicle 100, the control system 102, the portable electronic device 104, the remote server 104, and/or various components thereof may vary from that depicted in FIG. 1 and described in connection therewith, in various embodiments. It will similarly be appreciated that the steps of the process 200 may differ from those depicted in FIG. 2, and/or that various steps of the process 200 may occur concurrently and/or in a different order than that depicted in FIG. 2, in various embodiments. It will similarly be appreciated that the displays 300, 400, 500 and associated features of FIGS. 3-5 may also differ in various embodiments.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method comprising:
obtaining an input as to a destination for a vehicle drive for a vehicle;
determining, via a processor, an expected duration of the vehicle drive to the destination; and
providing, via instructions provided by the processor, a content list of a plurality of content items for entertainment of one or more passengers of the vehicle, based on the expected duration of the vehicle drive and a running time for each of the plurality of content items.

2. The method of claim 1, wherein the step of providing the content list comprises identifying the plurality of content items that are consistent with known preferences of the one or more passengers and that have running times that are consistent with the expected duration of the vehicle drive.

3. The method of claim 1, wherein the step of providing the content list comprises sorting the plurality of content items in order of compatibility of the respective running times with the expected duration of the vehicle drive.

4. The method of claim 1, further comprising:
receiving a selection input from the one or more passengers from the content list; and
playing a selected content item on a display inside the vehicle for the one or more passengers based on the selection input.

5. The method of claim 4, further comprising:
determining a route for the vehicle drive for travel of the vehicle to the destination; and
generating an overlay of the route interposed with the selected content item, showing where along the route the selected content item will be played on the display inside the vehicle.

6. The method of claim 1, further comprising:
receiving selection inputs from the one or more passengers from the content list; and
generating a queue of selected content items for the vehicle drive based on the selection inputs.

7. The method of claim 6, further comprising:
determining a route for the vehicle drive for travel of the vehicle to the destination; and
generating an overlay of the route interposed with the selected content items of the queue, showing where along the route the selected content items from the queue will be played on a display inside the vehicle.

8. A system comprising:
an input device configured to obtain an input as to a destination for a vehicle drive for a vehicle; and
a processor coupled to the input device and configured to:
determine an expected duration of the vehicle drive to the destination; and
provide a content list of a plurality of content items for entertainment of one or more passengers of the vehicle, based on the expected duration of the vehicle drive and a running time for each of the plurality of content items.

9. The system of claim 8, wherein the processor is configured to provide the content list at least in part by identifying the plurality of content items that are consistent with known preferences of the one or more passengers and that have running times that are consistent with the expected duration of the vehicle drive.

10. The system of claim 8, wherein the processor is configured to provide the content list at least in part by sorting the plurality of content items in order of compatibility of the respective running times with the expected duration of the vehicle drive.

11. The system of claim 8, wherein:
the input device is further configured to receive a selection input from the one or more passengers from the content list; and
the processor is further configured to provide instructions for playing a selected content item on a display inside the vehicle for the one or more passengers based on the selection input.

12. The system of claim 11, wherein the processor is further configured to:
determine a route for the vehicle drive for travel of the vehicle to the destination; and
generate an overlay of the route interposed with the selected content item, showing where along the route the selected content item will be played on the display inside the vehicle.

13. The system of claim 8, wherein:
the input device is further configured to receive selection inputs from the one or more passengers from the content list; and
the processor is further configured to generate a queue of selected content items for the vehicle drive based on the selection inputs.

14. The system of claim 13, wherein the processor is further configured to:
determine a route for the vehicle drive for travel of the vehicle to the destination; and
generate an overlay of the route interposed with the selected content items, showing where along the route the selected content items from the queue will be played on a display inside the vehicle.

15. A vehicle comprising:
an input device configured to obtain an input as to a destination for a vehicle drive for the vehicle;
a processor coupled to the input device and configured to:
determine an expected duration of the vehicle drive to the destination; and
generate a content list of a plurality of content items for entertainment of one or more passengers of the vehicle, based on the expected duration of the vehicle drive and a running time for each of the plurality of content items; and
a display coupled to the processor and configured to provide the content list in accordance with instructions provided by the processor.

16. The vehicle of claim 15, wherein the processor is configured to generate the content list at least in part by identifying the plurality of content items that are consistent with known preferences of the one or more passengers and that have running times that are consistent with the expected duration of the vehicle drive, and by sorting the plurality of content items in order of compatibility of respective running times with the expected duration of the vehicle drive.

17. The vehicle of claim 15, wherein:
the input device is further configured to receive a selection input from the one or more passengers from the content list;
the processor is further configured to provide instructions for playing a selected content item on the display inside the vehicle for the one or more passengers based on the selection input; and
the display is further configured to play the selected content item inside the vehicle for the one or more passengers based on the selection input, in accordance with the instructions provided by the processor.

18. The vehicle of claim 15, wherein:
the processor is further configured to:
determine a route for the vehicle drive for travel of the vehicle to the destination; and
generate an overlay of the route interposed with the selected content item, showing where along the route the selected content item will be played on the display inside the vehicle; and
the display is further configured to provide the overlay inside the vehicle for the one or more passengers, based on instructions provided by the processor.

19. The vehicle of claim 15, wherein:
the input device is further configured to receive selection inputs from the one or more passengers from the content list;
the processor is further configured to generate a queue of selected content items for the vehicle drive based on the selection inputs; and
the display is further configured to provide the queue of the selected content items inside the vehicle for the one or more passengers based on the selection inputs, in accordance with instructions provided by the processor

20. The vehicle of claim 15, wherein:
the processor is further configured to:
determine a route for the vehicle drive for travel of the vehicle to the destination; and
generate an overlay of the route interposed with the selected content items, showing where along the route the selected content items from the queue will be played on the display inside the vehicle; and
the display is further configured to provide the overlay inside the vehicle for the one or more passengers, based on instructions provided by the processor.
